(19) United States
(12) Patent Application Publication
(10) Pub. No.: US 2026/0197417 A1
(43) Pub. Date: Jul. 9, 2026

(54) IMAGE CAPTURING APPARATUS, CONTROL METHOD THEREFOR, AND STORAGE MEDIUM

(71) Applicant: CANON KABUSHIKI KAISHA, Tokyo (JP)

(72) Inventor: HIROYASU MORITA, Kanagawa (JP)

(21) Appl. No.: 19/557,940

(22) Filed: Mar. 5, 2026

Related U.S. Application Data
(63) Continuation of application No. PCT/JP2024/028743, filed on Aug. 9, 2024.

(30) Foreign Application Priority Data
Sep. 7, 2023 (JP) 2023-145573

(51) Int. Cl. H04N 5/77

(52) U.S. Cl. CPC H04N 5/77

(57) ABSTRACT

An image capturing apparatus includes a recording unit configured to record a captured image to a recording medium; and a transfer unit configured to transfer the image recorded in the recording medium to an external device, wherein the recording unit records, to the recording medium, management data managing an image transfer state regarding transfer to the external device by the transfer unit, as data for each image folder recorded in the recording medium.

### CROSS-REFERENCE TO RELATED APPLICATIONS

This application is a Continuation of International Patent Application No. PCT/JP2024/028743, filed August 9, 2024, which claims the benefit of Japanese Patent Application No. 2023-145573, filed September 7, 2023, both of which are hereby incorporated by reference herein in their entirety.

### BACKGROUND

### Field of the Technology

The present disclosure relates to a technique for managing a transfer state when transferring a shot image to an external device.

### Description of the Related Art

With improvements in network transfer speeds in recent years, image capturing apparatuses are being developed which transfer shot images to external devices over a network, either automatically or manually. A variety of devices, such as FTP (File Transfer Protocol) servers, smartphones, and the like are conceivable as external devices to which images are transferred.

Such image capturing apparatuses often include a function for managing the transfer of images such that it can be understood that images have been transferred to an external device. For example, an image capturing apparatus is known in which when an image is transferred to a smartphone and the transfer is successful, a display indicating that the transfer was successful is provided when the transferred image is played back on the image capturing apparatus side.

A variety of techniques have been proposed with respect to control for such image transfer management. For example, methods such as writing a transfer state into the header of an image file, using a separate file to manage information pertaining to image transfer management, and the like are known.

Japanese Patent Laid-Open No. 2009-086800 discloses the following technique. When an image is transmitted from a server to a client, a transmission history is updated and a transmission history list is transmitted from the server to the client. The client views the transmission history list transmitted from the server, and requests the server to transmit files other than files already received.

Japanese Patent Laid-Open No. 2014-526103 discloses the following technique. In a mobile terminal, stored image files and directories in which the image files are stored are monitored for changes, and when some kind of change is detected, details of the detected change are reflected in a log file. The log file is then transmitted to another device and used.

However, the above-described Patent Literature makes no mention of transfer management control with respect to a limited resource (e.g., RAM) when transferring large numbers of images in a case where transfer management data is managed as a separate file.

### SUMMARY

Having been achieved in light of the foregoing issue, the present disclosure provides an image capturing apparatus capable of appropriate transfer management with limited resources even when the number of images subject to transfer management increases.

An image capturing apparatus according to the present disclosure comprising: at least one processor or circuit and a memory storing instructions to cause the at least one processor or circuit to perform operations of the following units: a recording unit configured to record a captured image to a recording medium; and a transfer unit configured to transfer the image recorded in the recording medium to an external device, wherein the recording unit records, to the recording medium, management data managing an image transfer state regarding transfer to the external device by the transfer unit, as data for each image folder recorded in the recording medium.

Features of the present disclosure will become apparent from the following description of embodiments with reference to the attached drawings.

### BRIEF DESCRIPTION OF DRAWINGS

FIG. 1 is a block diagram illustrating the configuration of an image capturing apparatus according to a first embodiment of the present disclosure.

FIG. 2 is a diagram illustrating an example of a screen displayed when performing processing for selecting an image to be transferred.

FIG. 3 is a flowchart illustrating control for managing transfer management data according to the first embodiment.

FIG. 4 is a diagram illustrating the structure of the transfer management data according to the first embodiment.

FIG. 5 is a flowchart illustrating control for managing transfer management data according to a second embodiment.

FIG. 6A is a diagram illustrating the structure of the transfer management data according to the second embodiment.

FIG. 6B is a diagram illustrating the structure of the transfer management data according to the second embodiment.

FIG. 7 is a flowchart illustrating control for managing transfer management data according to a third embodiment.

FIG. 8A is a diagram illustrating the structure of the transfer management data according to the third embodiment.

FIG. 8B is a diagram illustrating the structure of the transfer management data according to the third embodiment.

FIG. 9A is a flowchart illustrating control for managing transfer management data according to a fourth embodiment.

FIG. 9B is a flowchart illustrating control for managing transfer management data according to the fourth embodiment.

FIG. 10 is a diagram illustrating the structure of the transfer management data according to the fourth embodiment.

### DESCRIPTION OF EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

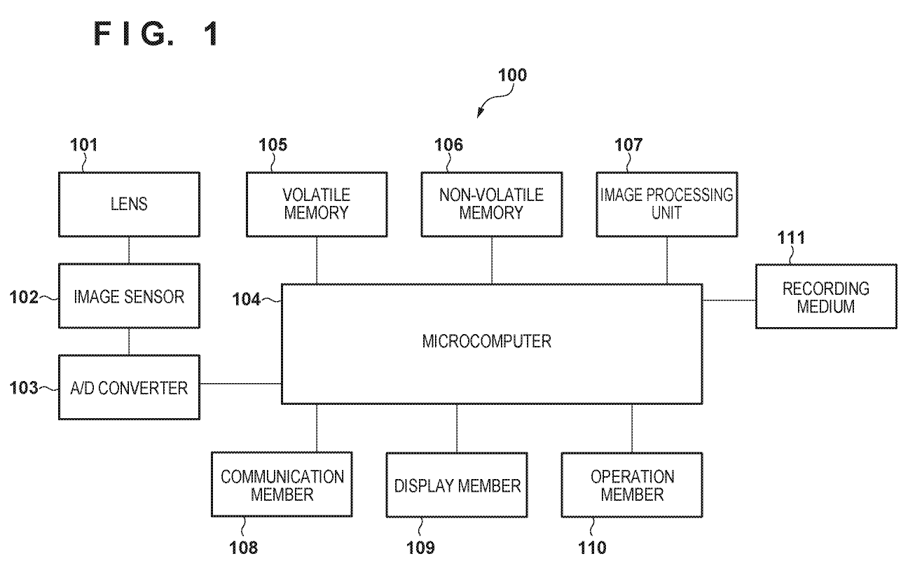

FIG. 1 is a block diagram illustrating the overall configuration of an image capturing apparatus 100 according to a first embodiment of the present disclosure.

In FIG. 1, a shooting lens 101 is constituted by a fixed focal-length lens, a zoom lens, and the like, and forms a subject image. An image sensor 102 is constituted by a CCD, a CMOS sensor, or the like, and converts the subject image formed by the shooting lens 101 into an electrical signal. An A/D converter 103 converts analog output signals from the image sensor 102 into digital signals.

A microcomputer 104 controls the image capturing apparatus 100 as a whole, including control of the various constituent elements, data processing, and the like. This includes, for example, controlling various parts on the basis of operation instructions from an operation member 110, generating images to be displayed on a display member 109, network control performed through a communication member 108, and the like. This also includes the selection of images to be transferred, transferring images to be transferred to an external device, referring to and updating transfer management data, control for reading out transfer management data from a recording medium 111 to a volatile memory 105, control for writing from the volatile memory 105 to the recording medium 111, and the like.

The volatile memory 105 temporarily holds image data converted into a digital signal by the A/D converter 103. Data for transfer management described in the present embodiment is also held here, and is referred to, updated, and the like by the microcomputer 104. A non-volatile memory 106 holds control programs for the image capturing apparatus, executed by the microcomputer 104. The non-volatile memory 106 also stores setting values of the image capturing apparatus.

An image processing unit 107 performs image processing on images that have been shot. The communication member 108 is a communication member for communication technology such as wireless LAN, for example. Either a wired connection or a wireless connection may be used for the communication technology. Although a technique such as FTP (File Transfer Protocol) transfer is assumed, another existing technique may be used instead.

The display member 109 is controlled by the microcomputer 104, and displays menus, plays back images, and the like. The operation member 110 is used to make operations on menus and the like displayed by the display member 109. The operation member is assumed to be an operation member such as keys, a touch panel, or the like. The recording medium 111 is assumed to be a CF card, an SD card, or the like, for example. Using the microcomputer 104, data can be written from the volatile memory 105 to the recording medium 111, data saved in the recording medium 111 can be read out to the volatile memory 105, and the like.

Transfer management according to the present embodiment will be described hereinafter while describing processing for selecting an image to be transferred and processing indicating an image for which transfer has failed, as an example of the function for handling transfer management data.

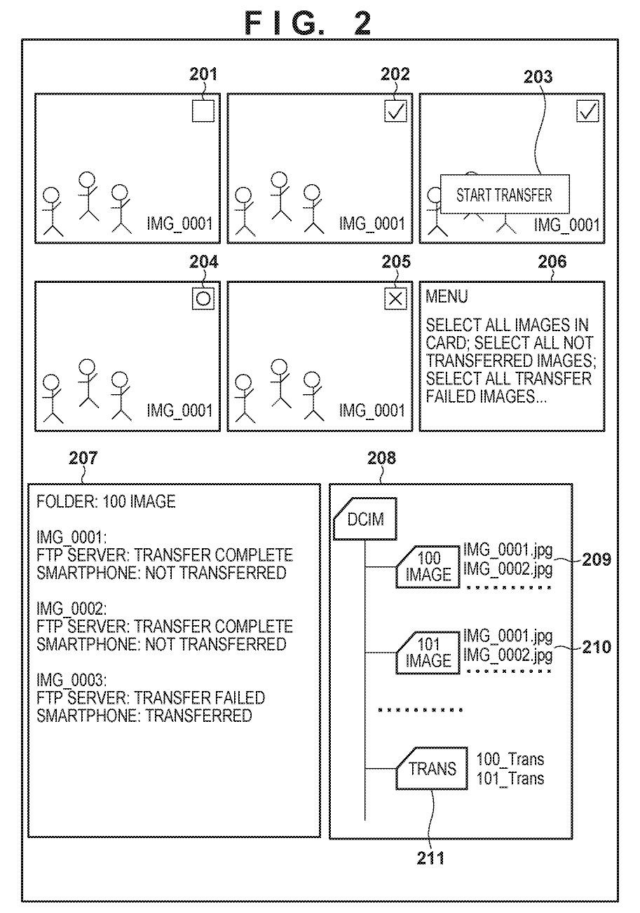

FIG. 2 is a diagram illustrating an example of a screen displayed when performing processing for selecting an image to be transferred. The descriptions will assume that “IMG_0001.jpg” is saved in the recording medium 111. A screen 200 indicates a screen of the display member 109 in which images saved in the recording medium 111 are played back by the image capturing apparatus 100. In this state, “IMG_0001.jpg” is being played back. A user sets which image to transfer while viewing the images displayed. Performing operations using the touch panel, keys, or the like of the operation member 110 is assumed as the operation method. A region 201 is a region indicating a state of transfer management, including information such as whether the image displayed has been transferred.

Image transfer management will be described here. “Transfer management” refers to managing a transfer state in association with an image, such as whether the image is to be transferred, whether the image has already been transmitted, whether the transfer of the image has failed, and the like. For example, when an image displayed in the screen 200 is selected by the user as an image to be transferred, the transfer management is performed assuming a “selected” state. For example, a checkmark indicator 202 is displayed as the display indicating “selected” transfer management. If a selected image indicated by the indicator 202 is present, the image in the “selected” state can be transmitted to a transfer destination by the user selecting “transfer”.

An explicit button such as a transfer start button 203 may be prepared, and the transfer may be started in response to the transfer start button 203 being pressed; or the indicator 202 being put into a selected state may be used as a trigger to start the transfer. The timing and conditions for starting the transfer are techniques publicly known for some time, and any method may therefore be used.

When the transfer is started in response to the transfer start button 203 being pressed, and is then completed, the image is managed in a “transferred” state as the image management. For example, the user can be notified that the image has been transferred by displaying a circular indicator 204.

An image for which the transfer has failed will also be described. When the transfer start button 203 is used to instruct a transfer and an attempt is made to transfer the image to the transfer destination, if a network error or the like occurs and the image cannot be transmitted to the transfer destination correctly, the image to be transferred is managed as a transfer failed image. For example, the user can be notified that the transfer of the image has failed by displaying an “x” indicator 205.

The foregoing has described a method for selecting whether to transfer a single image displayed by the display member 109, but a screen such as a menu 206 may be displayed, and options enabling a plurality of images to be selected at once may be provided to the user. It is assumed that the image selection can be provided through a publicly-known technique.

A data structure and control for managing the above-described transfer states will be described next. 207 indicates an example of transfer management data.

The transfer destination and the transfer state are recorded for each image file. As indicated by 207, when an FTP server and a smartphone are assumed as transfer destinations, the transfer state is recorded for each of those transfer destinations.

For example, 207 indicates that the image IMG_0001 has been successfully transferred to the FTP server but has not yet been transferred to the smartphone. Although the state of transfer to the assumed transfer destinations is stored for each image, the present embodiment assumes that the structure of the transfer management data can be provided through a publicly-known technique.

A save location of the transfer management data will be described next. The present embodiment assumes a method in which the transfer management data is stored in a file format. 208 indicates an example of a folder structure in the image capturing apparatus 100 when shot images are stored in the recording medium 111.

A DCIM folder is present directly below the recording medium 111. 209 indicates that the image IMG_0001.jpg is an image saved in or below a 100 IMAGE folder.

For example, when managing transfer management data such as that indicated by 207 at the level of shooting folders, images saved in or below the 100 IMAGE folder are handled as a single transfer management file. Additionally, when shot images are present in or below a 101 IMAGE folder as indicated by 210, those images are handled as a separate transfer management file.

The units, method, and the like for generating the transfer management file will be described in greater detail later. Control is performed such that the transfer management file itself is saved in the recording medium 111 and read out to the volatile memory 105 at the necessary timing; and the transfer management data in the volatile memory 105 is referenced and updated, and written back to the recording medium 111.

With respect to the location where the transfer management file is saved in the recording medium 111, there is a method in which the data is recorded to the same folder as the shot image, for example. As a specific example, the transfer management data of an image saved in or below the 100 IMAGE folder is saved in or below the 100 IMAGE folder. A control method in which a dedicated folder for transfer management data is generated is also conceivable as another method. For example, as indicated by 211, a folder “TRANS” for saving transfer management data may be generated in or below the DCIM folder, and the transfer management data may be saved therein. The location and method for recording the transfer management data are not particularly limited in the present embodiment.

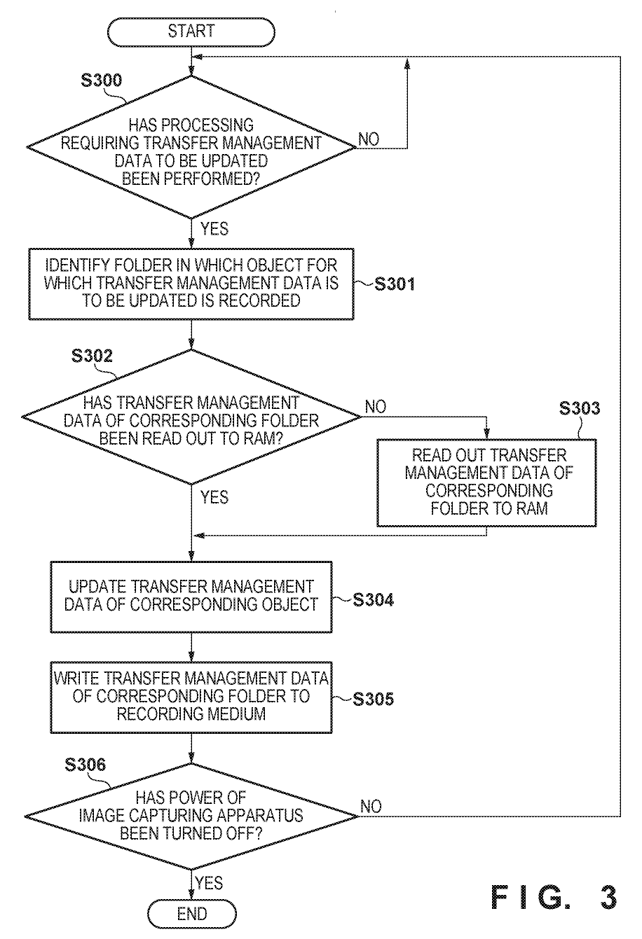

FIG. 3 is a flowchart illustrating control for managing the transfer management data for each folder in which shot images are saved. Note that the operations of the flowchart illustrated in FIG. 3 are implemented by the microcomputer 104 loading a control program stored in the non-volatile memory 106 to the volatile memory 105 and executing the program. The same applies to the flowcharts of the second and subsequent embodiments.

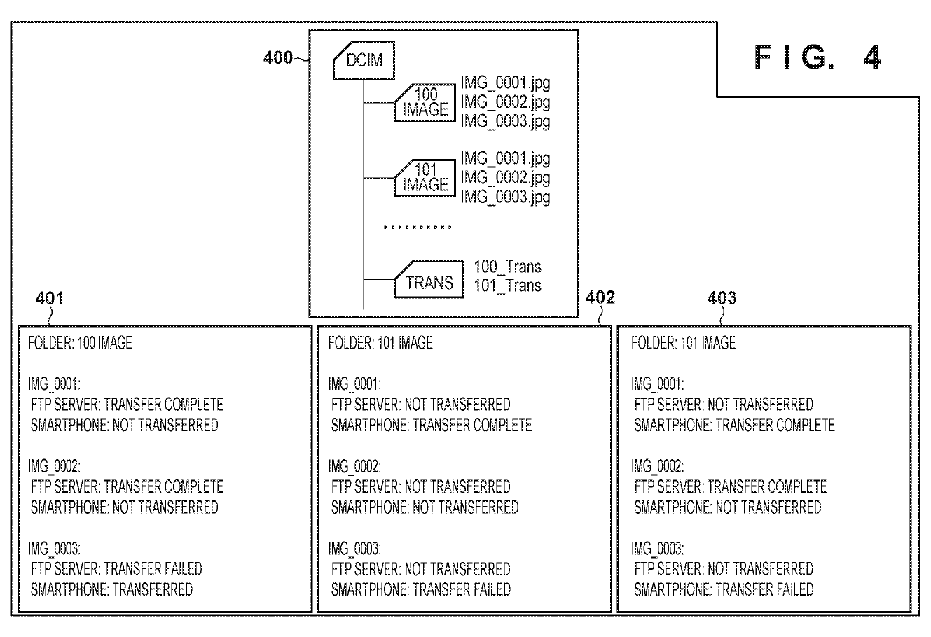

Note that the following descriptions assume that the images saved in the recording medium 111 and the transfer management data file are in a state such as that indicated by 400 in FIG. 4. Specifically, IMG_0001.jpg, IMG_0002.jpg, and IMG_0003.jpg are saved in the 100 IMAGE folder and the 101 IMAGE folder, respectively. Transfer management files 100_Trans and 101_Trans are present in or below the TRANS folder, and these transfer management files manage the images saved in the 100 IMAGE folder and the 101 IMAGE folder, respectively, at the folder level. 401 indicates the details of the transfer management data of the transfer management file 100_Trans. 402 indicates the details of the transfer management data of the transfer management file 101_Trans. The data of the transfer management file 100_Trans has been read out to the volatile memory 105, whereas the data of the transfer management file 101_Trans has not been read out to the volatile memory 105.

First, in step S300, the microcomputer 104 determines whether processing requiring the transfer management data to be updated has been performed. The “processing requiring the transfer management data to be updated” refers to processing for selecting an image to be transferred having been performed, the transfer of an image being complete, the transfer of an image having failed, and the like, as described earlier. As indicated by 403 in FIG. 4, the present embodiment will describe, as an example, processing in which the transfer of IMG_0002.jpg in the 101 IMAGE folder to the FTP server is complete.

If, in step S300, the processing requiring the transfer management data to be updated has been performed, the microcomputer 104 moves the sequence to step S301, and if not, the processing of step S300 is repeated.

In step S301, the microcomputer 104 identifies a folder in which is recorded an object for which the transfer management data is to be updated. In the present embodiment, the transfer management data for IMG_0002.jpg in the 101 IMAGE folder is to be updated, and the 101 IMAGE folder is therefore the corresponding folder.

In step S302, the microcomputer 104 confirms whether the transfer management file 101_Trans in the corresponding folder, i.e., the 101 IMAGE folder, has been read out to the non-volatile memory 105. The microcomputer 104 moves the sequence to step S304 if the file has been read out, and moves the sequence to step S303 if the file has not been read out.

Here, as described above, the data of the transfer management file 101_Trans has not been read out to the volatile memory 105, and thus a determination of No is made in step S302, and the sequence moves to step S303.

In step S303, the microcomputer 104 reads out the transfer management file of the corresponding folder from the recording medium 111 to the volatile memory 105. Specifically, the data of the transfer management file 101_Trans indicated by 400 in FIG. 4 is read out to the volatile memory 105. The transfer management file read out to the volatile memory 105 is assumed to be in the state indicated by 402.

In step S304, the microcomputer 104 updates the transfer management file in the corresponding folder.

In this example, because the transfer of IMG_0002.jpg in the 101 IMAGE folder to the FTP server is complete, the region managing the transfer state of IMG_0002.jpg to the FTP server is updated from “not transferred” to “transfer complete”, as indicated by 403 in FIG. 4.

In step S305, the microcomputer 104 writes the transfer management file of the corresponding folder to the recording medium 111.

Specifically, the data of the transfer management file 101_Trans read out to the volatile memory 105 in step S303 and updated in step S304 is written to the TRANS folder of the recording medium 111.

Recording the transfer management data to the recording medium 111 as a file in step S305 makes it possible to store the transfer management data even if the power of the image capturing apparatus 100 is turned off.

In step S306, the microcomputer 104 confirms whether the power of the image capturing apparatus 100 has been turned off. If the power has been turned off, the microcomputer 104 performs processing for shutting down the image capturing apparatus 100. If the power has not been turned off, the sequence returns to step S300, and the performance of the processing for updating the transfer management data is awaited.

According to the present embodiment, transfer management data can be managed for each folder in which shot images are saved. By managing the data for each folder, when loading the data to the volatile memory 105, space may be prepared in the volatile memory 105 according to the number of shots that can be saved in the folder. Accordingly, a transfer management function can be provided when using limited resources even when the number of images subject to transfer management increases, which makes it possible to prevent a drop in usability for the user.

### Second Embodiment

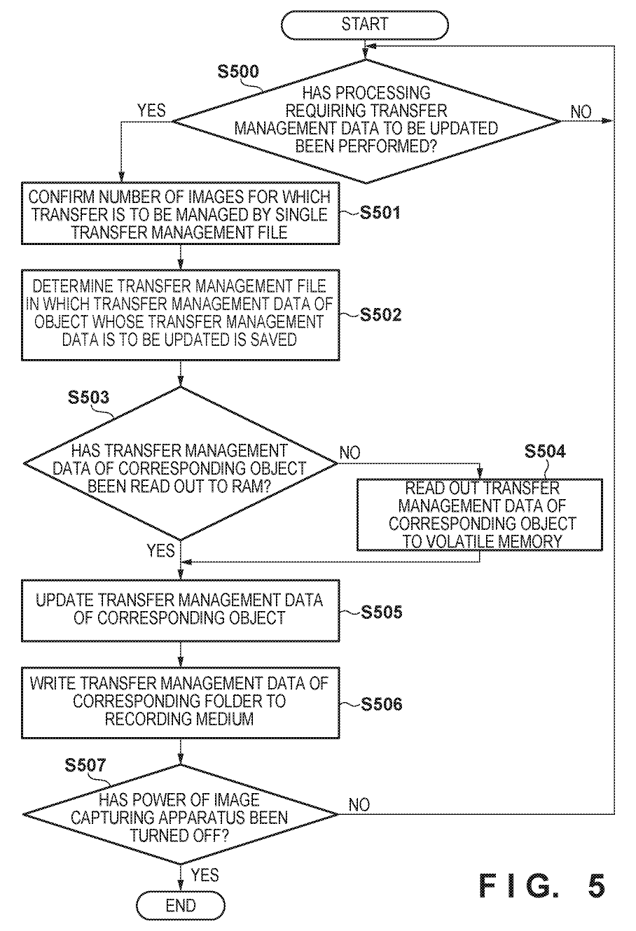

FIG. 5 is a flowchart illustrating control for generating a transfer management file for each group of a predetermined number of images, according to a second embodiment.

An example of generating transfer management data as a file for each group of the predetermined number of images will be described hereinafter.

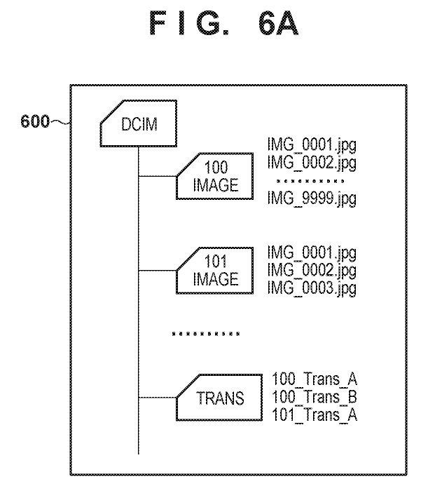

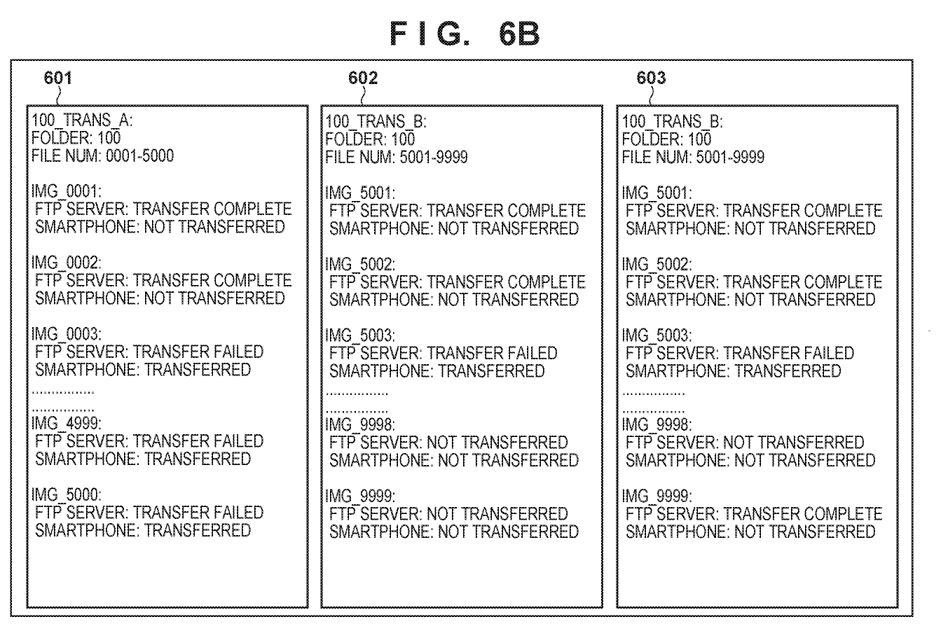

It is assumed here that shot images and a transfer management file are saved in the recording medium 111 in a state such as that indicated by 600 in FIG. 6A.

Specifically, a total of 9,999 images from IMG_0001.jpg to IMG_9999.jpg are saved in the 100 IMAGE folder. Although the images present in a single folder were managed as a single transfer management file in the first embodiment, a transfer management file is generated for each group of the predetermined number of images in the second embodiment.

The predetermined number may be any desired number, and may be determined in any manner. The present embodiment assumes that 9,999 images can be saved in a single folder, and therefore assumes that a single transfer management file is generated for half that number, e.g., 5,000 images. 601 and 602 indicate examples of the transfer management data for the images in the 100 IMAGE folder.

601 indicates the transfer state of images 0001 to 5000 in the 100 IMAGE folder, recorded in or under the TRANS folder with the filename 100_Trans_A. 602 indicates the transfer state of images 5001 to 9999 in the 100 IMAGE folder, recorded in or under the TRANS folder with the filename 100_Trans_B.

The second embodiment will describe, as an example, a case where the transfer of IMG_9999.jpg in the 100 IMAGE folder to the FTP server from the states indicated by 600, 601, and 602 described above is complete. These descriptions assume that the transfer management file 100_Trans_B has not been read out to the volatile memory 105.

In step S500, the microcomputer 104 determines whether processing requiring the transfer management data to be updated has been performed. The present embodiment will describe a case where the transfer of IMG_9999.jpg in the 100 IMAGE folder to the FTP server is complete.

In step S501, the microcomputer 104 confirms the number of images for which the transfer is to be managed by a single transfer management file. This is 5,000 in the present embodiment.

In step S502, the microcomputer 104 determines the transfer management file in which the transfer management data of the object whose transfer management data is to be updated is saved.

Here, the transfer management data of IMG_9999.jpg in the 100 IMAGE folder is to be updated, and the corresponding transfer management file is therefore confirmed. Because the number of images for which the transfer is to be managed by a single transfer management file is 5,000, and the number of the image is 9999, it can be seen that the corresponding transfer management file is 100_Trans_B.

In step S503, the microcomputer 104 confirms whether the corresponding transfer management file has been read out to the non-volatile memory 105. The microcomputer 104 moves the sequence to step S505 if the file has been read out, and moves the sequence to step S504 if the file has not been read out.

As described earlier, the transfer management file 100_Trans_B has not been read out to the volatile memory 105 here, and thus a determination of No is made in step S503, after which the sequence moves to step S504.

In step S504, the microcomputer 104 reads out the transfer management file 100_Trans_B from the recording medium 111 to the volatile memory 105.

In step S505, the microcomputer 104 updates the transfer management data in the corresponding transfer management file. As indicated by 603 in FIG. 6B, the region managing the transfer state of IMG_9999.jpg of the transfer management file 100_Trans_B to the FTP server is updated from “not transferred” to “transfer complete”.

In step S506, the microcomputer 104 writes the corresponding transfer management file to the recording medium 111.

In step S507, the microcomputer 104 confirms whether the power of the image capturing apparatus 100 has been turned off. If the power has been turned off, the microcomputer 104 performs processing for shutting down the image capturing apparatus 100. If the power has not been turned off, the sequence returns to step S500, and performance of the processing for updating the transfer management data is awaited.

According to the present embodiment, a transfer management file can be generated for each group of the predetermined number of images. Generating a transfer management file for each group of the predetermined number of images makes it possible to adjust the memory size when loading data to the volatile memory 105. As a result, a transfer management function can be provided when using limited resources even when the number of images subject to transfer management increases, which makes it possible to prevent a drop in usability for the user.

### Third Embodiment

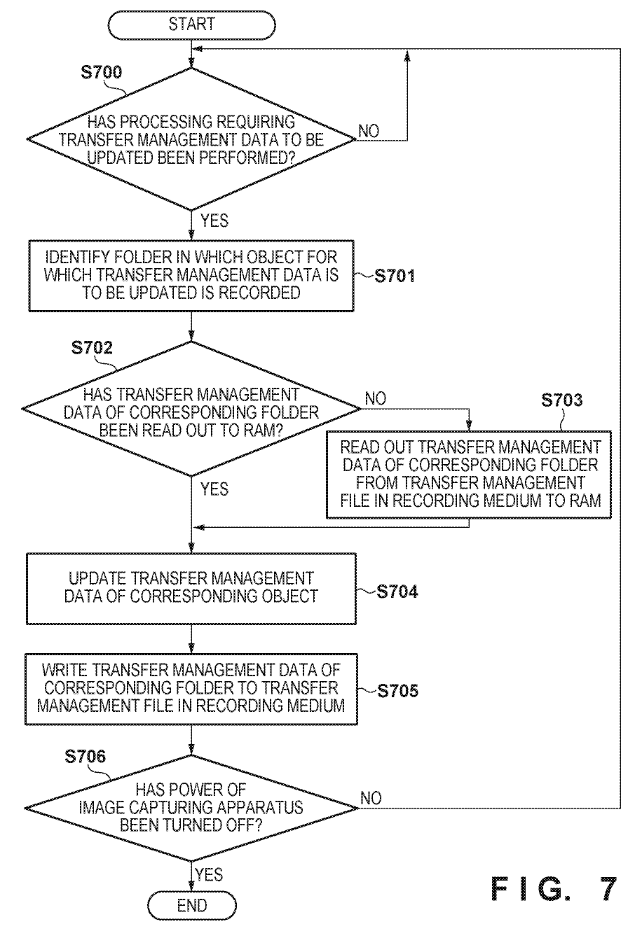

FIG. 7 is a flowchart illustrating control according to a third embodiment, in which transfer management data in a single file is segmented on a folder-by-folder basis, the transfer management data is read out from a recording medium for each folder-based segment, and the transfer management data is furthermore written to a recording medium.

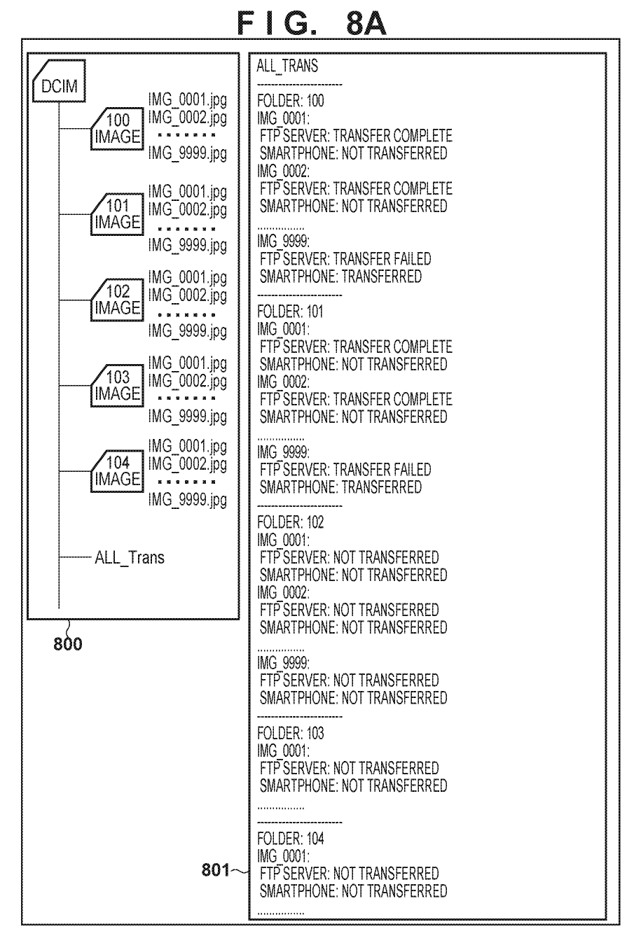

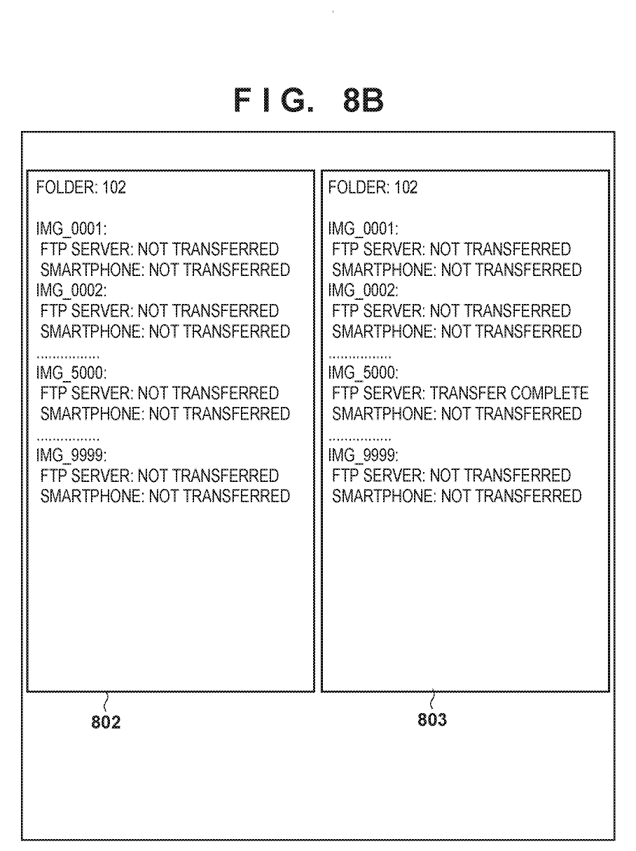

It is assumed here that shot images and a transfer management file are saved in the recording medium 111 in a state such as that indicated by 800 in FIG. 8A.

Specifically, a total of 9,999 images from IMG_0001.jpg to IMG_9999.jpg are saved in the 100 IMAGE folder. Likewise, a total of 9,999 images from IMG_0001.jpg to IMG_9999.jpg are saved in 101 to 104 IMAGE folders, respectively.

Although the transfer management data is managed as a file, in the present embodiment, the transfer management data of all images is managed as a single transfer management file.

801 indicates an example of the data structure of the transfer management file. It can be seen that segments are provided for each folder. As an example, a case will be described where the transfer of IMG_5000.jpg in the 102 IMAGE folder to the FTP server is complete. Note that the descriptions assume that the transfer management data for images in the 102 IMAGE folder has not been read out to the volatile memory 105.

In step S700, the microcomputer 104 determines whether processing requiring the transfer management data to be updated has been performed. The present embodiment will describe a case where the transfer of IMG_5000.jpg in the 102 IMAGE folder to the FTP server is complete.

In step S701, the microcomputer 104 identifies a folder in which is recorded an object for which the transfer management data is to be updated. Here, the transfer management data for IMG_5000.jpg in the 102 IMAGE folder is to be updated, and the 102 IMAGE folder is therefore the corresponding folder.

In step S702, the microcomputer 104 confirms whether the transfer management data in the corresponding folder, i.e., the 102 IMAGE folder, has been read out to the non-volatile memory 105. The microcomputer 104 moves the sequence to step S704 if the file has been read out, and moves the sequence to step S703 if the file has not been read out.

Here, as described above, the transfer management data in the 102 IMAGE folder has not been read out to the non-volatile memory 105, and thus a determination of No is made in step S702, and the sequence moves to step S703.

In step S703, the microcomputer 104 reads out the transfer management data of the corresponding folder from the recording medium 111 to the volatile memory 105. At this time, as indicated by 801, a single transfer management file is present, and thus if the transfer management file is large, it may not be possible to read out all the data to the volatile memory 105. Accordingly, of the data 801 in the recording medium 111, only the data corresponding to the 102 IMAGE folder is read out from the recording medium 111 to the volatile memory 105. 802 in FIG. 8B indicates this state.

In step S704, the microcomputer 104 updates the transfer management data of the corresponding object. In the present embodiment, because the transfer of IMG_5000.jpg in the 102 IMAGE folder to the FTP server is complete, the region managing the transfer state of IMG_5000.jpg to the FTP server is updated from “not transferred” to “transfer complete”, as indicated by 803 in FIG. 8B.

In step S705, the microcomputer 104 writes the transfer management data of the corresponding folder to the recording medium 111. At this time, the transfer management data indicated by 803 is written back to the position from which the data was read out from the recording medium 111 in step S703.

In step S706, the microcomputer 104 confirms whether the power of the image capturing apparatus 100 has been turned off. If the power has been turned off, the microcomputer 104 performs processing for shutting down the image capturing apparatus 100. If the power has not been turned off, the sequence returns to step S700, and performance of the processing for updating the transfer management data is awaited.

According to the present embodiment, segmenting the transfer management data in a single file on a folder-by-folder basis makes it possible to read out or write the transfer management data from or to a recording medium for each folder-based segment. By managing the data at the folder level, when loading the data to the volatile memory 105, space may be prepared in the volatile memory 105 according to the number of shots that can be saved in the folder. Accordingly, a transfer management function can be provided when using limited resources even when the number of images subject to transfer management increases, which makes it possible to prevent a drop in usability for the user.

The present embodiment has described an example in which the image transfer data is segmented on a folder-by-folder basis, read out from the recording medium 111 to the volatile memory 105, and then written from the volatile memory 105 to the recording medium 111. However, the unit by which the data is segmented is not limited to folders. For example, a certain number of images may be set as in the second embodiment, and the segments may be determined using that number as a unit. The segmentation method is not particularly limited.

### Fourth Embodiment

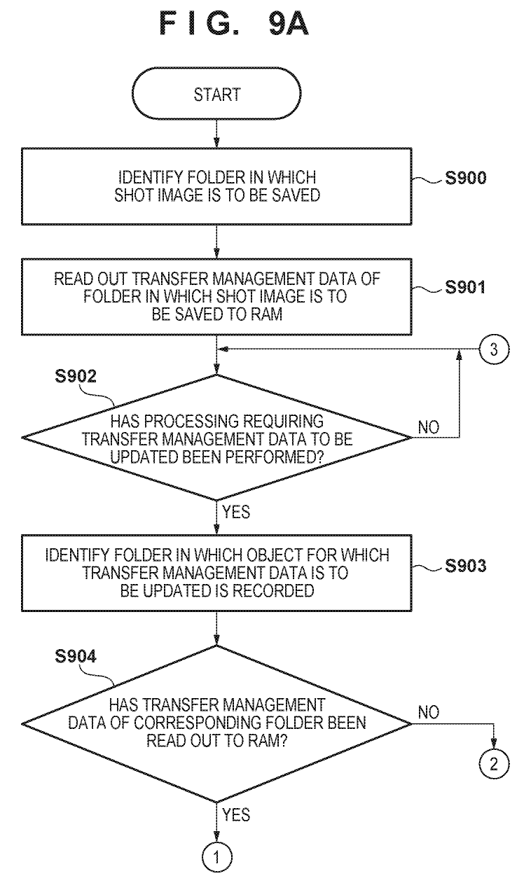

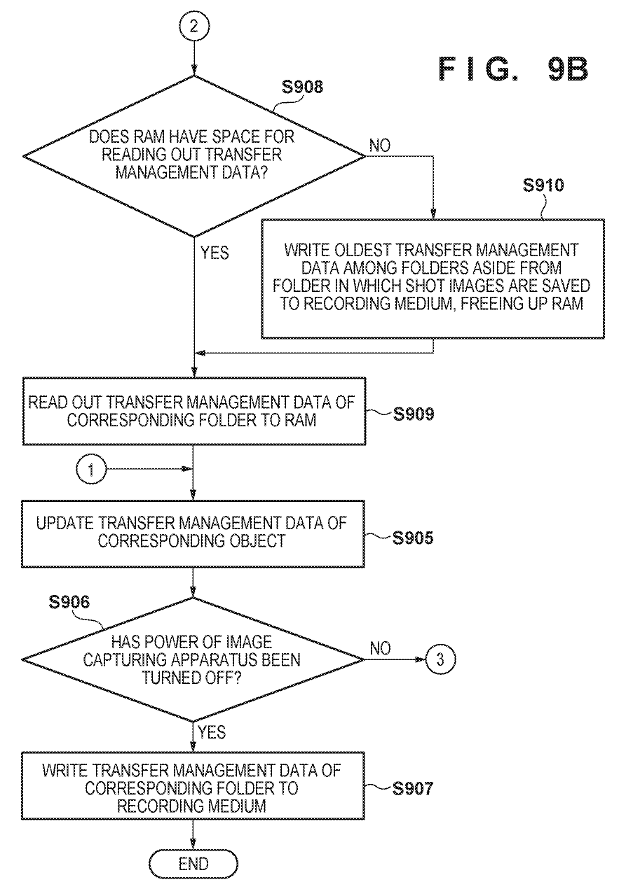

FIGS. 9A and 9B are flowcharts illustrating transfer management data control performed when managing transfer management data on a folder-by-folder basis according to a fourth embodiment, in which a folder estimated to be highly likely to be accessed is prioritized.

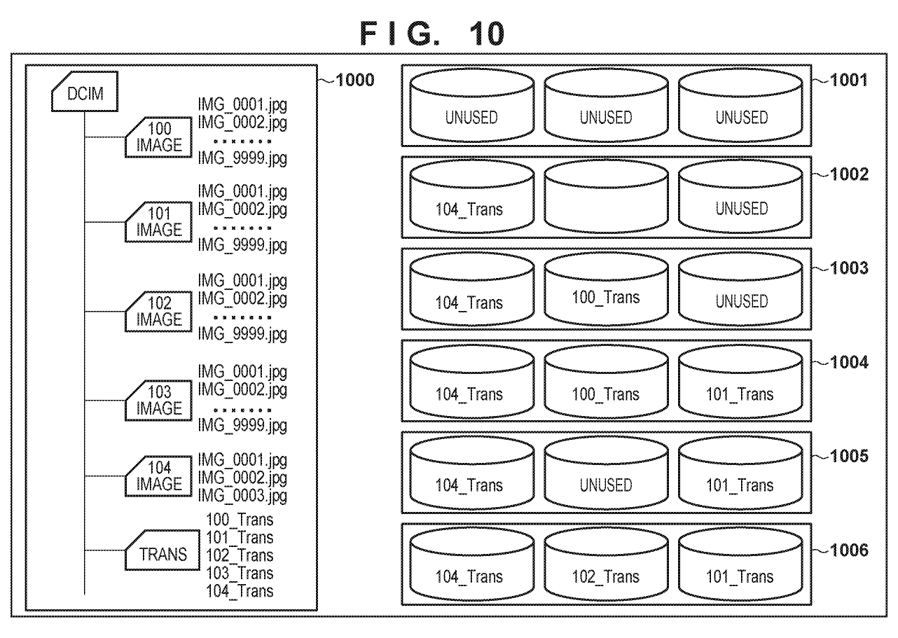

It is assumed here that shot images and a transfer management file are saved in the recording medium 111 in a state such as that indicated by 1000 in FIG. 10.

Specifically, a total of 9,999 images from IMG_0001.jpg to IMG_9999.jpg are saved in 100 to 103 IMAGE folders, respectively. IMG_0001.jpg to IMG_0003.jpg are saved in a 104 IMAGE folder.

A function for playing back images is one function of an image capturing apparatus. There is also a function for displaying the newest shot image as the image to be played back when a playback instruction is received. The descriptions in the present embodiment will assume that the newest shot image is the image that is played back. It is also assumed that when a new image is shot, that image is saved as IMG_0004.jpg in the 104 IMAGE folder. Furthermore, it is assumed that transfer management files 100_Trans to 104Trans for managing the transfer state on a folder-by-folder basis are present in the recording medium 111 as transfer management files that store the transfer management data of the shot images.

The present embodiment also assumes that when the transfer management data is read out from the recording medium 111 to the volatile memory 105, a plurality of regions in the volatile memory 105 are prepared (the volatile memory 105 has a plurality of storage regions). 1001 indicates an example thereof. 1001 indicates that regions are prepared in the volatile memory 105 to hold three items of transfer management data read out from the recording medium 111. Processing performed when transferring IMG_0001.jpg of the 100 IMAGE folder, IMG_0002.jpg of the 101 IMAGE folder, and IMG_0003.jpg of the 102 IMAGE folder to the FTP server from this state will be described hereinafter as an example.

In step S900, the microcomputer 104 identifies a folder in which a newly-shot image is to be saved. As described above, in the present embodiment, the newly-shot image is saved in the 104 IMAGE folder as IMG_0004.jpg, and the folder identified in step S900 is therefore the 104 IMAGE folder.

In step S901, the microcomputer 104 reads out the transfer management data of the folder in which the newly-shot image is to be saved (here, the 104 IMAGE folder) to the volatile memory 105.

In step S902, the microcomputer 104 reads out the transfer management file 104_Trans from the recording medium 111 to the volatile memory 105. 1002 indicates the state of the volatile memory 105 at that time. Of the three regions in the volatile memory 105, one region is being used by the data of the single transfer management file 104_Trans.

In step S902, the microcomputer 104 determines whether processing requiring the transfer management data to be updated has been performed. If the processing requiring the transfer management data to be updated has been performed, the microcomputer 104 moves the sequence to step S903, and if not, the processing of step S902 is repeated.

The present embodiment assumes that IMG_0001.jpg in the 100 IMAGE folder has been transferred to the FTP server in step S902.

In step S903, the microcomputer 104 identifies a folder in which an object for which the transfer management data is to be updated is present. Here, this is 100 IMAGE.

In step S904, the microcomputer 104 confirms whether the transfer management data in the corresponding folder has been read out to the volatile memory 105. The microcomputer 104 moves the sequence to step S905 if the data has been read out, and moves the sequence to step S908 if not.

In the state indicated by 1002 for the volatile memory 105, the transfer management file 100_Trans, in which the transfer management data of 100 IMAGE is managed as a file, has not been read out to the volatile memory 105. Accordingly, a determination of No is made in step S904, after which the sequence moves to step S908.

In step S908, the microcomputer 104 confirms whether the volatile memory 105 has space for reading out the transfer management data. The microcomputer 104 moves the sequence to step S909 if such space is present, and moves the sequence to step S910 if such space is not present.

In the current state of the volatile memory 105, indicated by 1002, two of the three regions are empty, and thus a determination of Yes is made in step S908, after which the sequence moves to step S909.

In step S909, the microcomputer 104 reads out the transfer management data of the corresponding folder to the volatile memory 105. Here, the transfer management file 100_Trans, which is the transfer management data of the 100 IMAGE folder, is read out.

1003 indicates the state of the volatile memory 105 after the readout. Two of the three regions are in use.

In step S905, the microcomputer 104 updates the transfer management data of the corresponding object. The updating of the transfer management data is performed in the same manner as in the foregoing embodiments, and will therefore not be described here.

In step S906, the microcomputer 104 confirms whether the power has been turned off. If the power has been turned off, in step S907, the microcomputer 104 writes the transfer management data of the corresponding folder to the recording medium 111, and ends the operations of this flow. In the present embodiment, the power has not been turned off in step S906, and thus a determination of No is made in step S906, after which the microcomputer 104 returns the processing to step S902.

Assume that in this state, IMG_0002.jpg in the 101 IMAGE folder is transferred to the FTP server. When the transfer of IMG_0002.jpg is complete, a determination of Yes is made in step S902, after which the microcomputer 104 moves the sequence to step S903.

In step S903, the microcomputer 104 identifies a folder in which an object for which the transfer management data is to be updated is present. Here, this is 101 IMAGE.

In step S904, the microcomputer 104 confirms whether the transfer management file 101_Trans in the 101 IMAGE folder has been read out to the volatile memory 105. The current state of the volatile memory is the state indicated by 1003.

Because the transfer management file 101_Trans has not been read out to the volatile memory 105, a determination of No is made in step S904, after which the microcomputer 104 moves the sequence to step S908.

In step S908, the microcomputer 104 confirms whether the volatile memory 105 has enough space for reading out the transfer management file 101_Trans. As indicated by 1003, the one remaining region is empty, and thus a determination of Yes is made in step S908; then, in step S909, the microcomputer 104 reads out the transfer management file 101_Trans to the volatile memory 105. The state of the volatile memory 105 at this time is the state indicated by 1004. All three regions are being used.

In step S905, the microcomputer 104 updates the transfer management data of IMG_0002.jpg in the 101 IMAGE folder, moves the sequence to step S906, and because the power is not turned off, returns the sequence to step S902.

Assume that in this state, IMG_0003.jpg in the 102 IMAGE folder is transferred to the FTP server. When the transfer of IMG_0003.jpg is complete, a determination of Yes is made in step S902, after which the microcomputer 104 moves the sequence to step S903.

In step S903, the microcomputer 104 identifies a folder in which an object for which the transfer management data is to be updated is present. Here, this is 102 IMAGE.

In step S904, the microcomputer 104 confirms whether the transfer management data 102_Trans in the 102 IMAGE folder has been read out to the volatile memory 105. The current state of the volatile memory is the state indicated by 1004.

Because the transfer management file 102_Trans has not been read out to the volatile memory 105, a determination of No is made in step S904, after which the microcomputer 104 moves the sequence to step S908.

In step S908, the microcomputer 104 confirms whether the volatile memory 105 has space for reading out the transfer management file 102_Trans. The current state of the volatile memory 105 is the state indicated by 1004. In this case, as indicated by 1004, all three regions of the volatile memory 105 are being used, and it is therefore determined that there is no space. A determination of No is therefore made in step S908, after which the microcomputer 104 moves the sequence to step S910.

In step S910, the microcomputer 104 writes the oldest transfer management data among the folders aside from the folder in which new shot images are saved to the recording medium 111, freeing up the volatile memory 105. The folder in which new shot images are saved is 104 IMAGE. Accordingly, the transfer management file 104_Trans is not subject to being moved to the recording medium 111.

The state of the volatile memory 105 is the state indicated by 1004, and transfer management files 100_Trans and 101_Trans are present in addition to the transfer management file 104_Trans.

In the present embodiment, the transfer management file 100_Trans read out from the volatile memory 105 earlier is determined to be older, and thus the data of the transfer management file 100_Trans is written back to the recording medium 111, freeing up the volatile memory 105. The state of the volatile memory 105 after this processing is the state indicated by 1005. The part where the transfer management file 100_Trans had been saved is freed up, and thus two of the three regions are being used.

In step S909, the microcomputer 104 reads out the transfer management data of the corresponding folder to the recording medium 111. In other words, the transfer management file 102_Trans is read out to the volatile memory 105. The state of the volatile memory 105 at this time is the state indicated by 1006. The transfer management file 102_Trans is read out, and all three regions of the volatile memory 105 are therefore being used. The processing following thereafter is the same as that described earlier, and will therefore not be described here.

Although the present embodiment has described a sequence using an example in which a folder in which newly-shot images are saved is taken as a folder highly likely to be accessed, the folder highly likely to be accessed is not limited thereto.

There are also image capturing apparatuses in which newly-shot images and the last image played back are stored separately. In such a case, the folder in which the playback image is saved may be taken as the folder highly likely to be accessed. There is also a function that saves still images and moving images in separate folders. In such a case, a folder that is highly likely to be accessed may be defined for both still images and moving images. In the present embodiment, how a folder that is highly likely to be accessed is determined is defined on the basis of individual product specifications.

Additionally, in step S910, the oldest item of management data aside from the management data corresponding to the folder highly likely to be accessed is selected as the target to be freed up from the volatile memory 105, but this item may be the oldest read-out item, or an item accessed after the readout may be the oldest item. The method for determining which transfer data to delete from the volatile memory 105, aside from the folder highly likely to be accessed, is not particularly limited.

The present embodiment has described control in which, when managing transfer management data on a folder-by-folder basis, transfer management files in a folder assumed to be likely to be accessed are kept in a state of being read out to the volatile memory 105, whereas other transfer management data is released. Through this control, when the transfer management data is written to the recording medium 111, the frequency at which the data is read out to the volatile memory 105 can be reduced. This makes it possible to lighten the processing load.

According to the present disclosure, appropriate transfer management can be performed with limited resources even when the number of images subject to transfer management increases.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM ), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image capturing apparatus comprising:
at least one processor or circuit and a memory storing instructions to cause the at least one processor or circuit to perform operations of the following units:
a recording unit configured to record a captured image to a recording medium; and
a transfer unit configured to transfer the image recorded in the recording medium to an external device,
wherein the recording unit records, to the recording medium, management data managing an image transfer state regarding transfer to the external device by the transfer unit, as data for each image folder recorded in the recording medium.

2. The image capturing apparatus according to claim 1, wherein the at least one processor or circuit is configured to further function as an storage unit configured to store the management data,
wherein the storage unit reads out the management data from the recording medium, and writes the management data back to the recording medium after the management data is updated in accordance with the image transfer state.

3. The image capturing apparatus according to claim 2, wherein the recording unit records the management data to the recording medium as a management file for each image folder.

4. The image capturing apparatus according to claim 3, wherein, for each image folder, the storage unit reads out the management file from the recording medium, and writes the management file back to the recording medium after the management file is updated in accordance with the image transfer state.

5. The image capturing apparatus according to claim 2, wherein the recording unit records the management data to the recording medium as a management file for each group of a predetermined number of images.

6. The image capturing apparatus according to claim 5, wherein, for each group of the predetermined number of images, the storage unit reads out the management file from the recording medium, and writes the management file back to the recording medium after the management file is updated in accordance with the image transfer state.

7. The image capturing apparatus according to claim 2, wherein the recording unit records the management data to the recording medium as a management file having a segment for each image folder.

8. The image capturing apparatus according to claim 7, wherein, for each segment, the storage unit reads out the management data from the recording medium, and writes the management data back to the recording medium after the management data is updated in accordance with the image transfer state.

9. The image capturing apparatus according to claim 7, wherein the management file is a single file.

10. The image capturing apparatus according to claim 2, wherein the storage unit has a plurality of storage regions.

11. The image capturing apparatus according to claim 10, wherein in a case where the management data is stored in all of the plurality of storage regions and it is necessary to update management data corresponding to another image folder, the storage unit clears, from among the plurality of storage regions, a region storing management data other than management data corresponding to a prioritized image folder, and stores management data for which updating is necessary.

12. The image capturing apparatus according to claim 11, wherein the prioritized image folder is a folder in which a newly-shot image is recorded.

13. The image capturing apparatus according to claim 11, wherein the prioritized image folder is a folder in which a playback image is saved.

14. A control method for an image capturing apparatus, the control method comprising:
recording a captured image to a recording medium; and
transferring the image recorded in the recording medium to an external device,
wherein in the recording, management data managing an image transfer state regarding transfer to the external device by the transferring is recorded to the recording medium as data for each image folder recorded in the recording medium.

15. A non-transitory computer-readable storage medium having stored therein program that causes a computer to execute a control method for an image capturing apparatus, the control method comprising:
recording a captured image to a recording medium; and
transferring the image recorded in the recording medium to an external device,
wherein in the recording, management data managing an image transfer state regarding transfer to the external device by the transferring is recorded to the recording medium as data for each image folder recorded in the recording medium.
